(19) United States
(12) Patent Application Publication
(10) Pub. No.: US 2009/0012942 A1
(43) Pub. Date: Jan. 8, 2009

(54) IN-STORE PETCARE INFORMATION AND ADVISORY CENTER

(75) Inventors: Neil Thorneycroft, Wodonga (AU); Andre Herbst, St. Leonards (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/166,900

(22) Filed: Jul. 2, 2008

(30) Foreign Application Priority Data
Jul. 3, 2007 (AU) 2007100603

(51) Int. Cl. G06F 17/30

(52) U.S. Cl. 707/3; 707/E17.014

(57) ABSTRACT

The invention is directed to a petcare information kiosk, for placement in a retail outlet for petcare products by a supplier of petcare products. The kiosk includes a searchable electronic database containing information relating to petcare, such as pet animal nutrition information, pet animal behavior information, pet animal health or well-being information; a user interface which allows a petcare product customer to search for and access the desired information in the database. The kiosk also includes an information output device, which allows the customer to retain the information once found and a support structure which allows the kiosk to be located in a location directly adjacent the petcare products offered for sale in the retail outlet.

### CROSS-REFERENCE TO RELATED APPLICATIONS

This application claims priority to AU Application No. 2007100603 filed Jul. 3, 2008.

### TECHNICAL FIELD

The invention relates to the field of retailing petcare products. In particular, the invention relates to an improved way to provide petcare information to purchasers of petcare products while they shop for said products.

### BACKGROUND OF THE INVENTION

In the competitive field of retailing petcare products, the ability to communicate the value or advantages of one's products to purchasers is a key to marketplace success. Successful communication in this area often rests on educating consumers of the health, well-being or behavioral issues which the petcare formulation is attempting to address or alleviate.

This is particularly so in relation to those products which are aimed at the more specialized ‘super premium’ end of the market. That is, products formulated for specific life stages and/or to influence particular animal health, nutrition or behavioral outcomes. These are usually branded separately to general retail petcare and food products, and are retailed in specialized outlets such as pet stores and veterinary clinics.

Traditionally, the advantages of such products are detailed entirely on the packaging of the products themselves. However, this can be a difficult medium in which to fully detail the advantages or uses of the product. In order to successfully direct the customer toward the specific advantages of a given product, it has been recognized that it would be advantageous to provide an information source at the retail location to allow customers to research particular conditions, and, if available, to direct the customer toward a particular product.

For example, some petcare product suppliers have provided a printed sourcebook of pet animal conditions, which can be available at a specialized petcare retailer, which customers can use for specific research. However, such a sourcebook does not readily provide ‘take home’ information for the customer, and there remain difficulties for the customer to readily recognize the products to which the manufacturer would prefer to direct the customer as a result of a particular enquiry.

In addition, such sourcebooks may not be ‘user friendly’ for members of the general public.

Accordingly it is an object of the present invention to provide a means for providing information regarding pet animal health, nutrition and/or behavior at a petcare retail outlet, which has an enhanced aspect compared with the prior art in a least one of the following: ease of use; ease of location with respect to the petcare manufacturers products; ease of ability of user to ‘take away’ information from the retail outlet.

### BRIEF SUMMARY OF THE INVENTION

According to one aspect of the invention, there is provided a petcare information kiosk, also known as a petcare advisory centre, for placement in a retail outlet for petcare products by a supplier of petcare products, said kiosk including:

a searchable electronic database containing information relating to petcare, such as pet animal nutrition information, pet animal behavior information, pet animal health and well-being information;

a user interface which allows a petcare product customer to search for and access the desired information in said database;

an information output device, which allows the customer to retain the information once found; and

a support structure which allows the kiosk to be located in a convenient location directly adjacent the petcare products offered for sale in said retail outlet.

The kiosk as described above allows the petcare product manufacturer/supplier to provide information to potential customers which is of general interest to those customers regarding their pets' health, nutrition or general well being.

However, a particular advantage of the kiosk is that, when a potential customer makes an enquiry about a particular pet health issue for which the manufacturer/supplier has a targeted product, the kiosk it will be able to instantly display information sufficient to readily identify to the potential customer the availability of that product at the retail store.

Another advantage of the kiosk is that it assists in establishing the credentials of the petcare manufacturer's brand in relation to pet health and nutrition issued by providing a link between easy-to-use and helpful expert information and the brand name.

It also allows a standardized information set to be distributed; thereby ensuring a consistent message is given by staff of the store in which the unit is placed.

Preferably, the support structure is integrated with display shelving used to display the petcare products in said retail outlets. This allows the targeted products as described above to be available immediately to hand, allowing the customer to obtain the products without further searching of shelves and particularly without further reference to competitor products.

The user interface, such as a touch screen, may advantageously be configured to indicate the precise position on the surrounding shelving of the targeted product, where the kiosk is incorporated in display shelving which are stacked in a consistently specified manner.

A further advantage may be realized wherein said information output device is an email connection, which has advantaged over a printer in that paper does not need to be restocked and in that the customer can transfer larger amounts of information (including, for example, web-links to other relevant websites) to their home computer to read at their leisure.

A further advantage may be realized wherein said information contained on the searchable database can be updated remotely via a wireless or internet connection. This allows the support structure to be placed in a wider variety of locations and configurations, as it is less likely that maintenance access to the physical device embodying the kiosk will be required.

According to another aspect of the invention, there is provided a method of providing in-store petcare information to a petcare product customer, said method including the steps of:

1) providing a petcare information kiosk in a petcare retail outlet, said kiosk including: a searchable electronic database containing information relating to petcare, including pet animal nutrition information, pet animal behavior information, pet animal health and well-being information; a user interface which allows a petcare product customer to search for and access the desired information in said database; and an information output device, which allows the customer to retain the information once found;

2) placing the kiosk in a support structure in said retail outlet, said support structure being adapted to allow placement of said user interface directly adjacent the petcare products offered for sale in said retail outlet.

Advantageously, said method further includes the steps of:

3) applying a particular shelf-stacking layout regime to the petcare products loaded on to said support structure; and

4) supplying data pertaining to said regime into said database, such that, if information supplied to answer to the customer's query includes a suggested petcare product, the user interface can direct the customer to the place on the support structure where said product can be found.

This greatly facilitates the ability of the petcare product provider to encourage the user of the kiosk to select and purchase specific products in response to information supplied by the kiosk.

Now will be described, by way of a specific, non-limiting example, a preferred embodiment of the invention.

### BRIEF DESCRIPTION OF THE DRAWINGS

FIG. 1 shows a perspective view of a ‘stand alone’ petcare information kiosk according to the invention.

FIG. 2 shows a sectional side view of the petcare information kiosk of FIG. 1.

FIG. 3 shows a perspective view of a petcare information kiosk according to the invention, when mounted integrally with product display shelving.

### DETAILED DESCRIPTION OF THE INVENTION

The following detailed description of an embodiment of the invention refers to the attached drawings, described above.

One of the main components of the information kiosk according to the invention is a computerized database, which is searchable via a search engine or similar program. The key information contained in the database includes dog and cat breed profiles and expert articles written in relation to pet animal nutrition, behavior and well-being. These materials provide the basis for customer enquiries at the kiosk.

For example: a customer performs a search on the database by entering a query on an area of interest; the search engine returns a link to one or more articles on the database according to their relevance to the customer's query; the customer then selects the article or articles of greatest interest, which may be read in-store, printed, or emailed to an address entered by the customer.

Preferably, where the petcare product manufacturer markets a product which is particularly relevant to meeting a need relating to the customer's query, some form of textual or visual cross reference may be made or triggered by the customer's query. This alerts the customer to the manufacturer's offering. Where the kiosk forms part of an integrated product display unit, the kiosk may additionally provide information regarding the precise location in the display unit of the particular product or products of relevance, thus making it easier for the customer to locate and select the product.

The database is loaded on to a computer hard drive, or similar device, which is mounted in to the kiosk. Optionally, other material may be included in the computer hard drive, such as attraction loops consisting of materials such as advertisements for the petcare material manufacturer's products. This draws attention to the kiosk and may be used to provide other information for the customer's benefit.

Another advantageous type of program which may be added to the hard drive is a ‘Select-a-Pet’ program, which leads the customer through a decision tree designed to enable them the select an appropriate pet or breed for their circumstances.

Another advantageous program which may be added to the hard drive is a ‘Petfood Calculator’ program, which enables the customer to calculate the correct feeding regime for their pet for a given range of foods supplied by the petcare manufacturer/supplier, based on inputs such as the animal's mass, age and breed.

The above software programs are to be understood to merely constitute examples of the type of programs that can be added to the kiosk. Many other appropriate programs may be added which would be equally advantageous.

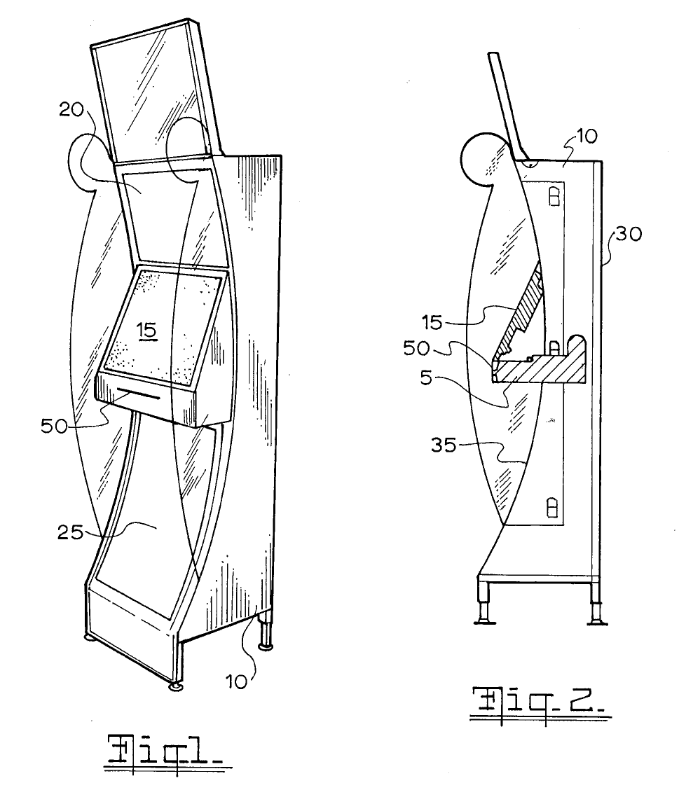

The interface between the customer and the computer hard drive is preferably provides via a touch-screen. As illustrated in FIGS. 1 and 2, the hard drive 5 is mounted in a relatively tall enclosed cabinet 10 and the touch screen 15 is set at a height for convenient use by the customer. The cabinet 10 is designed to have a number of surfaces that are suitable for displaying brand livery or optionally specific advertising or promotional material. For example, the kiosk illustrated in FIG. 1 has a receptacle 20 for a changeable A3 size poster mounted above the screen 15 and a receptacle 25 for a changeable A2 size poster mounted below the screen.

FIG. 2 illustrates the relative positioning of the key elements of the kiosk. There is provided a cabinet 10 having a substantially vertical rear panel 30 and a relatively concave curved front panel 35. A computer hard drive 5 (with attached printer mounted at the front, toward the curved panel 35) is mounted inside the cabinet 10 at about half-way between the top and bottom of the cabinet. Above the hard-drive 5 is mounted an angled touch-screen display unit 15 which is angled back toward the rear panel 30 for ease of viewing and use.

It will also be noted that the front and side surfaces of the kiosk feature very prominent brand livery for the petcare brand, in the illustration the ADVANCE brand is used. This assists in establishing the brand presence in-store and in associating the brand with the petcare expertise contained in the kiosk database.

The front of the touch-screen 15 also features a horizontal slot 50 through which articles or pages resulting from a customer enquiry can be received when printed via the printer installed in the cabinet and connected the computer hard drive.

Alternatively, once the customer has located information of particular interest, the system can invite the customer to enter their email address, to which the relevant information can be sent.

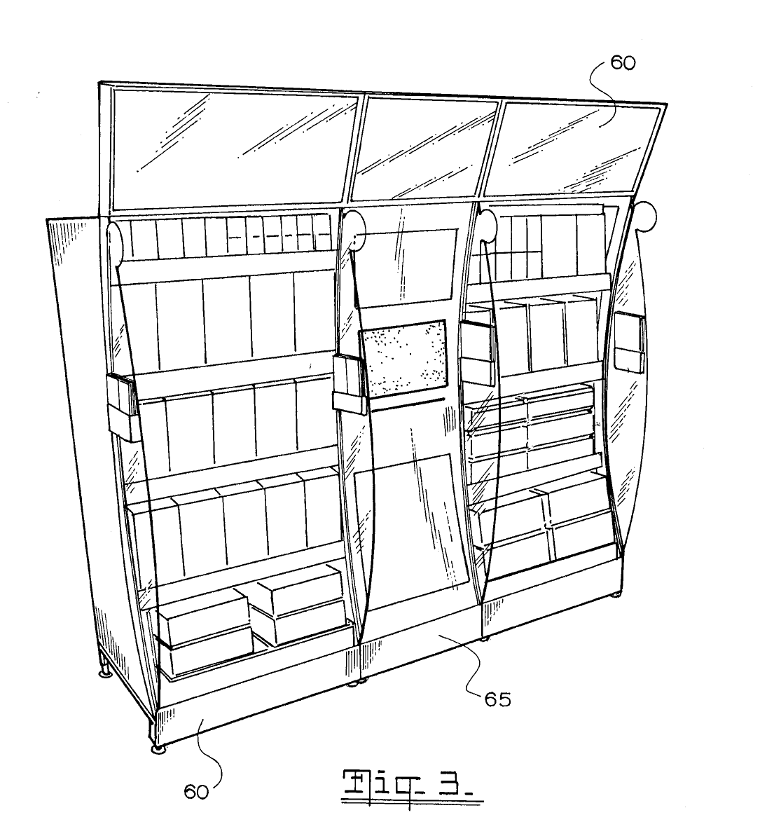

Turning to FIG. 3, there is illustrated the positioning or mounting of a similar kiosk 65, having broadly the same features as the kiosk 10 in FIG. 1, in an integrated display in between two complementary product shelving units 60. When mounted in this manner, the petcare products that are identified in the database information are placed easily to hand when they are suggested to the customer.

In particular, where a specific shelf-stocking regime is applied to the shelving units, the touch-screen display may be able to indicate precisely the point on the shelf where the product can be found.

It will be appreciated by those skilled in the art that the above described embodiments of the invention are not the only ways in which the inventive concept may be put into effect. Other embodiments are of course conceivable which, while different in some details, nevertheless fall within the spirit and scope of the invention.

What is claimed is:

1. A petcare information kiosk, for placement in a retail outlet for petcare products by a supplier of petcare products, said kiosk including:
a searchable electronic database containing information relating to petcare, such as pet animal nutrition information, pet animal behaviour information, pet animal health or well-being information;
a user interface which allows a petcare product customer to search for and access the desired information in said database;
an information output device, which allows the customer to retain the information once found; and
a support structure which allows the kiosk to be located in a location directly adjacent the petcare products offered for sale in said retail outlet.

2. The petcare information kiosk of claim 1, wherein said support structure is integrated with display shelving used to display the petcare products in said retail outlets.

3. The petcare information kiosk of claim 1, wherein said information output device is an email connection.

4. The petcare information kiosk of claim 1, wherein said information output device is a paper printer.

5. The petcare information kiosk of claim 1, wherein the information contained on the searchable database can be updated remotely via a wireless data connection.

6. The petcare information kiosk of claim 1, wherein the information contained on the searchable database can be updated remotely via an internet connection.

7. A method of providing in-store petcare information to a petcare product customer, said method including the steps of:
providing a petcare information kiosk in a petcare retail outlet, said kiosk including: a searchable electronic database containing information relating to petcare, including pet animal nutrition information, pet animal behaviour information, pet animal health and well-being information;
whereby said kiosk includes a user interface which allows a petcare product customer to search for and access the desired information in said database;
the kiosk further including an information output device, which allows the customer to retain the information once found; and
placing the kiosk in a support structure in said retail outlet, said support structure being adapted to allow placement of said user interface directly adjacent the petcare products offered for sale in said retail outlet.

8. The method of claim 7, further including the steps of:
applying a particular shelf-stacking layout regime to the petcare products loaded on to said support structure; and
supplying data pertaining to said regime into said database, such that, if information supplied to answer to the customer's query includes a suggested petcare product, the user interface can direct the customer to the place on the support structure where said product can be found.

9. The method of claim 7, wherein said information output device is an email connection.

10. The method of claim 7, wherein said information output device is a paper printer.

11. The method of claim 7, wherein the information contained on the searchable database is updated remotely via a wireless data connection.

12. The method of claim 7, wherein the information contained on the searchable database is updated remotely via an internet connection.
